(19) United States
(12) Patent Application Publication
(10) Pub. No.: US 2006/0171848 A1
(43) Pub. Date: Aug. 3, 2006

(54) Diagnostic plasma sensors for endpoint and end-of-life detection

(75) Inventors: Gregory A. Roche, Fort Collins, CO (US); Daniel C. Carter, Fort Collins, CO (US); David W. Madsen, Fort Collins, CO (US); Leonard J. Mahoney, Fort Collins, CO (US)

Correspondence Address: JOHN D. PIRNOT;ADVANCED ENERGY INDUSTRIES, INC., 1625 SHARP POINT DR., FORT COLLINS, CO, 80525, US

(73) Assignee: Advanced Energy Industries, Inc.

(21) Appl. No.: 11/047,256

(22) Filed: Jan. 31, 2005

(51) Int. Cl. G01N 27/00

(52) U.S. Cl. 422/98

(57) ABSTRACT

A plasma measurement device comprises data sensors for sensing properties of the plasma environment together with diagnostic sensors for measuring properties related to the functional integrity of the measurement device. Events reported by the diagnostic sensors of the invention may be interpreted as failures of the measurement device, as warnings requiring operator attention or intervention, or alternatively may be employed as data in a predictive algorithm to estimate the remaining useful lifetime of the device. By providing an ability to detect events indicative of faults or failures in a plasma measurement device during use of the device, the invention provides enhanced certainty and confidence in the integrity of data collected by the plasma measurement device.

### BACKGROUND OF THE INVENTION

1. Field of the Invention

This invention relates generally to devices for in-situ measurement of plasma properties within a plasma processing system, and more particularly to plasma measurement devices having onboard diagnostic sensors for monitoring the condition and useful life of the measurement device.

2. Brief Description of the Prior Art

Recent advances in the technology of in-situ plasma metrology allow for virtually noninvasive measurements of actual physical and electrical properties of a plasma within an operational plasma processing environment. For example, sensor devices may be disposed upon a wireless wafer-based probe device that may be cycled like any other workpiece into the process environment, or alternatively may be disposed in fixed arrays within the processing equipment itself. Descriptions of exemplary apparatus and methods for in-situ, noninvasive plasma metrology may be found in U.S. Pat. No. 6,830,650 and U.S. patent application Ser. No. 10/640,892, both owned by the assignee of the present application.

Because in-situ plasma measurement devices are intended to be disposed in close proximity to a process environment, they are necessarily exposed to the often harsh thermal, chemical, and electrical conditions of the plasma. Even where care is taken to construct a measurement device of materials that are tolerant of the plasma environment, wear of the device is inevitable due to the aggressive nature of the plasma. For example, the sensors and onboard electronics of a diagnostic measurement device can be expected to erode and degrade in performance over time with repeated deployment of the device in chemical etch or ion sputtering process as a result of chemical and physical interactions with the plasma. Alternatively, the performance of a measurement device disposed in a deposition process may deteriorate due to an accumulation of deposited materials upon the sensors and other features of the device. In either case, it must be anticipated that the effective operational lifetime of a diagnostic in-situ plasma device will be limited due to actions of the plasma upon the measurement device.

Repeated contact with the plasma environment may cause one or more sensors of a measurement device to fail abruptly, interrupting a data acquisition sequence and terminating the utility of the device. On the other hand, the performance of a diagnostic sensor may degrade only partially with exposure to the plasma, causing errors in the data collected by the sensor. If this loss of data integrity cannot be detected or anticipated, erroneous inferences may follow about spatial and temporal plasma conditions and their suitability to a process recipe. Where a measurement device is relied upon for characterization or real-time control of critical and high-value plasma processes, the appearance of faults or inaccuracies in the diagnostic data can lead to worse results than having no data at all, particularly if action is taken to correct the plasma processing system on the bases of faulty or inaccurate measurements.

The useful lifetime of a plasma sensor can be estimated through statistical analysis of sensor degradation and failure when placed in specific environments, although it is always possible that a sensor will fail earlier than expected. It would be desirable to provide an ability to detect events indicative of faults or failures in a plasma measurement device during use of the device and independent of application in any specific plasma process. It would be further desirable to provide data for use in assessing the functional condition of the plasma measurement device or estimating its remaining useful lifetime. It would be further desirable if the diagnostic sensors could provide in-situ data relating to rates or properties of substrate surface modification resulting from actions of the plasma.

### SUMMARY OF THE INVENTION

This invention provides a plasma measurement device having integrated sensors for self-diagnosis of the condition and performance of the device. A measurement device of the invention generally comprises a substrate having one or more integrated primary data sensors for sensing properties of the plasma environment, together with one or more diagnostic sensors for measuring properties related to the functional integrity of the measurement device. Alternatively, diagnostic sensors are employed as primary data sensors for in-situ measurement of rates or properties of substrate surface modification resulting from actions of the plasma.

In one embodiment of the invention, a wafer-based plasma measurement probe comprises one or more “fuse” sensors that register a fault event when a protective passivation layer of the probe has been sufficiently eroded by actions of the plasma. The fuse sensors comprise a consumable conductive strip electrically connected to controlling electronics of the probe and covered by a thinned portion of the protective passivation layer. Upon exposure to the plasma, the thinned portion of the passivation layer erodes away to expose the consumable conductive strip, which is then itself eroded. The loss of electrical continuity due to erosion of the conductive strip causes a fault event to be registered by the probe electronics. The dimensions and material compositions of the conductive strip and thinned passivation layer are selected so as to ensure that the failure event occurs while the principal data sensors and interconnections of the measurement probe are still intact, but prior to a time that the integrity of data collection from the data sensors would become significantly degraded from further erosion by the plasma.

In another embodiment of the invention, an “anti-fuse” structure registers a fault or diagnostic event as the result of sensing changes in impedance or capacitance in an electrical path through the plasma. The diagnostic sensors comprise a first electrode exposed to the plasma and a second electrode covered by a thinned passivation layer. As the thinned passivation layer is eroded by the plasma, controlling electronics connected to the electrodes register a decrease in impedance in the conduction path between the electrodes through the plasma, or alternatively an increase in capacitance. The diagnostic sensor may also be configured for use in a deposition process, whereby material deposited upon exposed electrodes of the sensor progressively alters electrical properties of a conduction path through the plasma. Diagnostic events reported by sensors of the invention may be interpreted as hard failures of the measurement device, as warnings requiring operator attention or intervention, or alternatively may be employed as data in a predictive algorithm to estimate the remaining useful lifetime of the device.

The invention also features the use of plasma data sensors as diagnostic sensors. For example, ion current sensors or optical emission sensors are adapted for diagnostic purposes by correlating measurements of the sensors to degrees of erosion or deposition of material layers upon the sensors. By providing an ability to detect events indicative of faults or failures in a plasma measurement device during use of the device, the invention provides enhanced certainty and confidence in the integrity of data collected by the device. The invention also provides a method of acquiring data for use in assessing the operational condition of the device or estimating its remaining useful lifetime.

In another aspect of the invention, the degradation process itself is used to detect or infer plasma process conditions. In this case, primary data sensors are designed to degrade or alter in response to plasma conditions, allowing the sensors to measure rates or properties of substrate surface modification resulting from actions of the plasma, such as etch or deposition rates. Data provided by etch or deposition rate sensors of the invention are used to compute process endpoints with high accuracy, as well as for development of process recipes, matching and optimization of process equipment, real-time monitoring and control of plasma processes, and periodic repeatability measurements to maintain process control.

### BRIEF DESCRIPTION OF THE DRAWINGS

FIG. 1 illustrates a wafer-based diagnostic plasma probe in accordance with one embodiment of the invention.

FIGS. 2a and 2b illustrate the structure and operation, respectively, of a diagnostic sensor in accordance with one embodiment of the invention.

FIGS. 3a and 3b illustrate the structure and operation, respectively, of a passivated electrode diagnostic sensor in accordance with a further embodiment of the invention.

FIGS. 4a and 4b illustrates the use of an insulated dual floating Langmuir probe as a diagnostic sensor in accordance with another embodiment of the invention.

FIGS. 5a and 5b illustrate the structure and operation, respectively, of a diagnostic sensor comprising a reactive solid state material layer and an optical emission sensor in accordance with a further embodiment of the invention.

### DETAILED DESCRIPTION

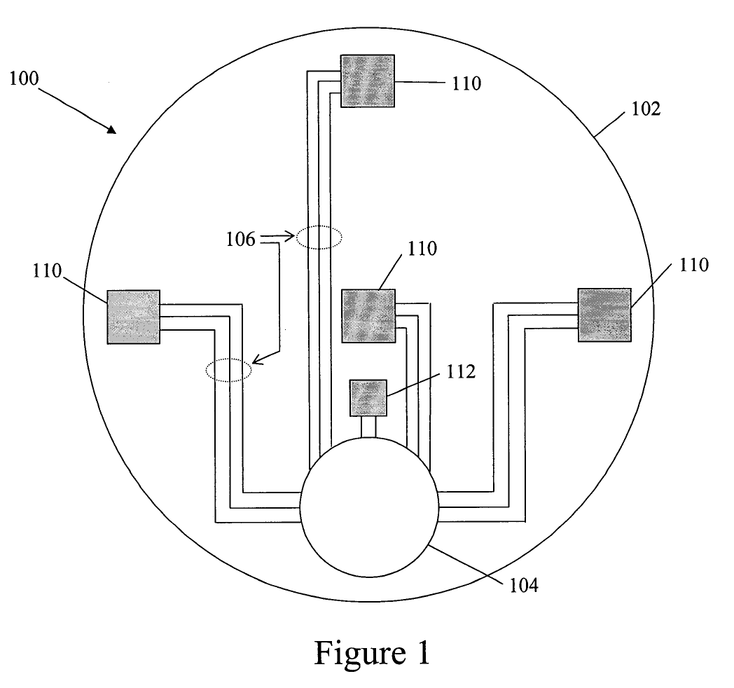

FIG. 1 illustrates a wafer-based plasma probe in accordance with one embodiment of the invention. Sensor probe 100 comprises a 200 mm or 300 mm silicon wafer primary substrate 102 having physical and electrical properties standard to typical semiconductor starting material. Probe 100 further comprises data sensors 110 for measurement of plasma or surface properties. Data sensors may include, for example, Langmuir probe sensors for measuring plasma ion currents and/or electron temperatures; electrostatic charge sensors; ion property sensors for measuring ion flux, energy distributions, or incidence angles; surface temperature sensors such as thermistors, thermocouples, or temperature diodes; optical sensors for measuring plasma optical emission spectroscopy or particle light scattering, or for absorption spectroscopy; surface acoustic wave sensors for measuring pressure, film thickness and deposition rates; or micro-electromechanical systems for tactile chemical sensing, mass spectrometry, ion energy and vibration measurements.

An electronics module 104 comprising onboard power and information processing and storage components of probe 100 is disposed upon the surface of probe substrate 102. Electronics module 104 further comprises a wireless communication interface that receives and transmits the sensor data outside of the plasma processing environment for further processing and analysis. Interconnections 106 are disposed upon substrate 102 for connection of sensors 110 to electronics module 104 and electrical components therein. A patterened dielectric surface passivation layer (not shown) is typically disposed upon the wafer surface for physical protection and electrical isolation of select probe components and features, including interconnections 106, from the plasma environment.

Probe 100 is introduced into a plasma processing environment, at which time the apparatus sensors and microprocessor are activated or triggered to collect data relating to surface or plasma properties in close proximity to the apparatus surface. While the probe is exposed to the plasma environment, energetic ions in the plasma may bombard the probe and react chemically or physically with its surface. Even where the protective passivation layer is comprised of a resilient material, however, such as a dielectric metal oxide or nitride, repeated deployment of the probe into the plasma environment will lead to wear of the passivation layer due to the aggressive nature of the plasma. Sufficient wear of the protective passivation layer will expose interconnections 106 and vulnerable elements of the data sensors 110 of the probe to attack by the plasma, leading eventually to loss of function and failure of the device.

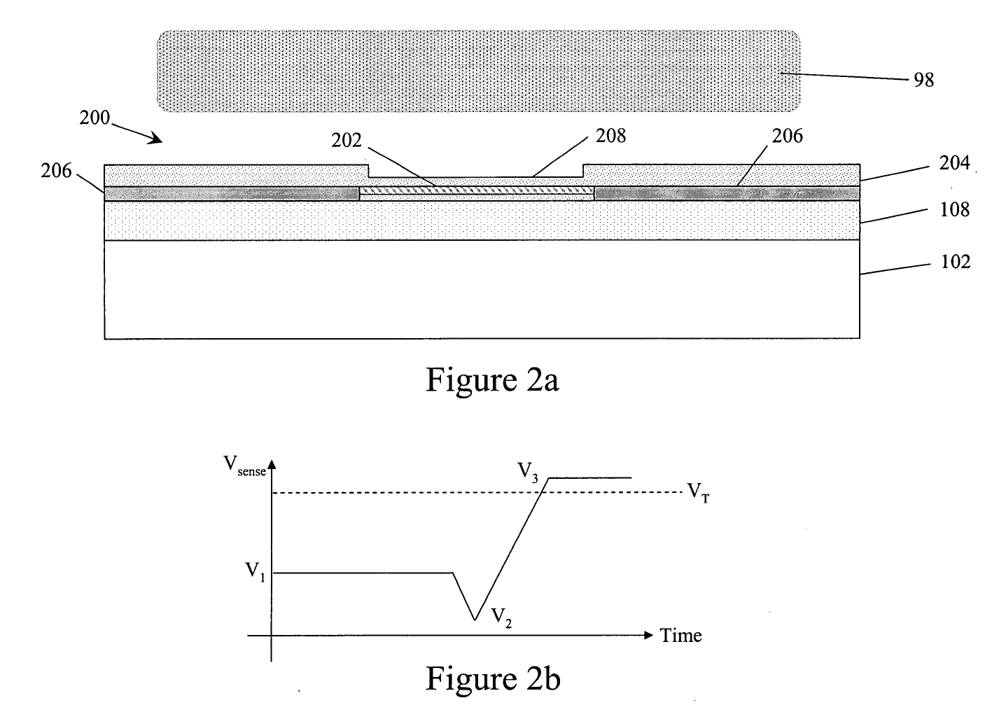

In accordance with the present invention, probe 100 further comprises one or more self-diagnostic sensors 112 for measuring properties related to the functional condition and integrity of probe 100. FIG. 2a illustrates a fuse sensor in accordance with one embodiment of the invention. Sensor 200 is disposed into a dielectric layer 108 upon the surface of wafer substrate 102. Sensor 200 comprises consumable conductive strip 202 disposed upon dielectric layer 108 covering the surface of wafer substrate 102. Consumable conductive strip 202 is electrically connected to interconnections 206 between the fuse sensor 200 and controlling electronics of the probe (not shown). Passivation layer 204 is disposed to protect interconnections 206 and other probe components (not shown) from the plasma environment. A thinned portion 208 of passiviation layer 204 covers consumable conductor strip 202. It will be understood that in FIG. 2a as well as in subsequent figures, the dimensions of certain illustrated features are not to scale but exaggerated for clarity.

Prior to exposure of the probe to a plasma environment, an electrical continuity exists between interconnections 206 through intact conductive strip 202 that can be sensed by the probe electronics resulting in a measured potential V₁, as shown in FIG. 2b. When measurement probe comprising diagnostic sensor 200 is deployed into a plasma environment such as a chemical etch process, passivation layer 204 begins to wear. Because of its reduced thickness, thinned portion 208 of the passivation layer is worn away to expose consumable conductor strip 202 to the plasma while the main protective portions of passivation layer 204 are substantially intact. When thinned layer 208 is removed and conductor strip 202 is exposed, a change in V₂ occurs in the potential across the strip as a result of exposure to the plasma, particularly if other conductive parts of probes or sensors are also exposed to the plasma. As the etching action of the plasma 98 continues, consumable conductive strip 202 is eroded until the electrical continuity between interconnections 206 diminishes resulting in an increase in signal voltage V₃. The loss of electrical continuity between interconnections 206 is sensed by processing electronics onboard the probe. When a threshold signal V_{T} is reached, a probe failure event is triggered. Loss or change of electrical continuity in the fuse sensor may be ascertained by detecting changes in voltage, resistance or impedance, or current through the sensor.

The dimensions and material compositions of conductive strip 202 and thinned layer 208 are selected so as to ensure that the failure event occurs while the principal data sensors and interconnections of the measurement probe are still intact, but just prior to the time that the integrity of data collection from the data sensors is anticipated to have become significantly degraded due to erosion by the plasma. In the example shown, one conductive strip 202 is constructed of a 1 k Å thick patterned layer of doped poly-silicon layer with sheet resistance of about 10 Ohm-square and dimensions of 100 μm long by 1 μm wide for a total resistance of 1 k Ohms. The thinned passivation layer 208 may be a 10 k Å thick silicon oxide layer while 204 may be a 20 k Å thick silicon oxide layer. In a typical oxide etch case, dielectric layers 208 and 204 would be etched away at approximately the same rates locally on the substrate with a removal rate of anywhere between 1 to 10 k Å/min. Because conductor strip 202 is composed of different material than the oxide, the conductive strip may etch away at a slower rate than dielectric layer 204. Conductive strip 202 is therefore made substantially thinner than the net difference of dielectric layers 204 and 208 so that a failure event can be detected before the entire thickness of protective layer 204 is cleared form the substrate.

Depending upon how quickly or slowly the failure event is intended to occur, thinned portion 208 of the passivation layer may be omitted so as to completely expose conductive strip 202 prior deployment of the probe device into the plasma environment. In alternative embodiments, layer 208 has a thickness equal to that of passivation layer 204 but is composed of a material that erodes more quickly than the passivation substance in the presence of the plasma. In any event, it is preferred that any consumable materials employed in diagnostic sensors of the invention be compatible with the process environment so that any erosion byproducts of the consumed materials do not cause undue contamination of process equipment or work pieces.

Self-diagnostic sensors of the invention, such as the fuse sensor illustrated in FIG. 2a, may be disposed in any quantity about the surface or body of a plasma measurement device. In one embodiment of the invention, an array of self-diagnostic sensors is disposed across the surface of a wafer-based plasma probe device in order to provide redundant or spatially resolved diagnostic information about the functional condition of the probe device. Alternatively, diagnostic sensor arrays of the invention comprise individual sensors constructed so as to experience failure events at progressively longer time intervals, by providing for example progressively thinner passiviation layers over the conductive fuse strips of an array that wear away correspondingly more quickly, so as to yield information about the rates of erosion occurring or the predicted time-to-failure of one or more of the data sensors. In another embodiment of the invention, sensors for diagnosing the condition of a plasma measurement device are disposed within a plasma processing environment separately from the measurement device. Failure events reported by the diagnostic sensors of the invention may be interpreted as hard failures of the measurement device, as warnings requiring operator attention or intervention, or alternatively may be employed as data in a predictive algorithm to estimate the remaining useful lifetime of the device.

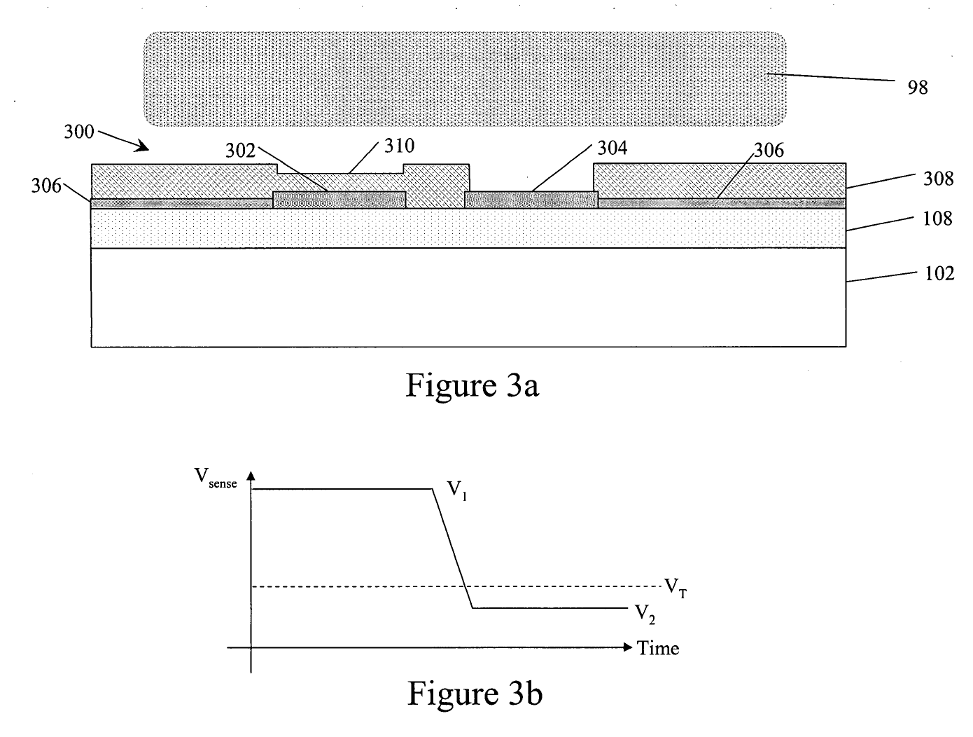

A self-diagnostic sensor in accordance with another embodiment of the invention is depicted in FIG. 3a. Sensor 300 is disposed into a dielectric layer 108 upon the surface of wafer substrate 102. Sensor 300 comprises embedded electrode 302 and exposed electrode 304, each connected electrically to interconnections 306 between the sensor 300 and controlling electronics of the plasma probe. Passivation layer 308 having thinned portion 310 is disposed over embedded electrode 302, while electrode 304 is exposed to the plasma. Prior to exposure of the probe to a plasma environment, a high impedance exists between electrodes 302 and 304 that can be sensed by probe electronics. When the measurement probe comprising diagnostic sensor 300 is deployed into a plasma etching or sputtering process, passivation layer 308 begins to wear, with thinned portion 310 wearing away to expose embedded electrode 302 while the main portions of passivation layer 308 that protect probe data sensors, interconnections and components are substantially intact. While embedded electrode 302 is exposed to the plasma, erosion of thinned portion 310 results in a drop in impedance between electrode 302 and exposed electrode 304 due to electrical conduction through the plasma. This reduced impedance (or increased conductivity) is sensed by device electronics as a drop in voltage across the sensor from V₁ to V₂, as illustrated in FIG. 3b. When voltage across the sensor drops to threshold voltage V_{T}, notification of a diagnostic event is triggered. Alternatively, the event may be sensed as a change in other electrical properties of the sensor circuit, such as an increase in capacitance between electrodes 302 and 304 due to erosion of thinned passivation layer 310 and exposure of electrode 302 to the plasma.

In an alternative embodiment, a self-diagnostic sensor is adapted for use in a physical or chemical vapor deposition process. In this embodiment, a pair of sensor electrodes such as the electrode pair depicted in the embodiment of FIG. 3a is disposed upon a dielectric layer of a wafer-based probe device, but without any passivation or dielectic protective layer covering either electrode. When the probe is initially deployed into a plasma-assisted deposition process, a characteristic impedance is sensed between the two electrodes due to conduction through the plasma. If the material deposited is dielectric, the impedance between the electrodes increases due to deposition of the dielectric material upon the electrodes. If the material deposited is conductive, impedance between the electrodes drops due to additional conduction through the accumulating conductive layer upon the probe surface. In either case, the change in electrical properties between the sensor electrodes is sensed by probe electronics, which may trigger a diagnostic event upon reaching a threshold signal level or may provide electrical signal information about insulating or conductive coatings in order to estimate the remaining useful lifetime of the device.

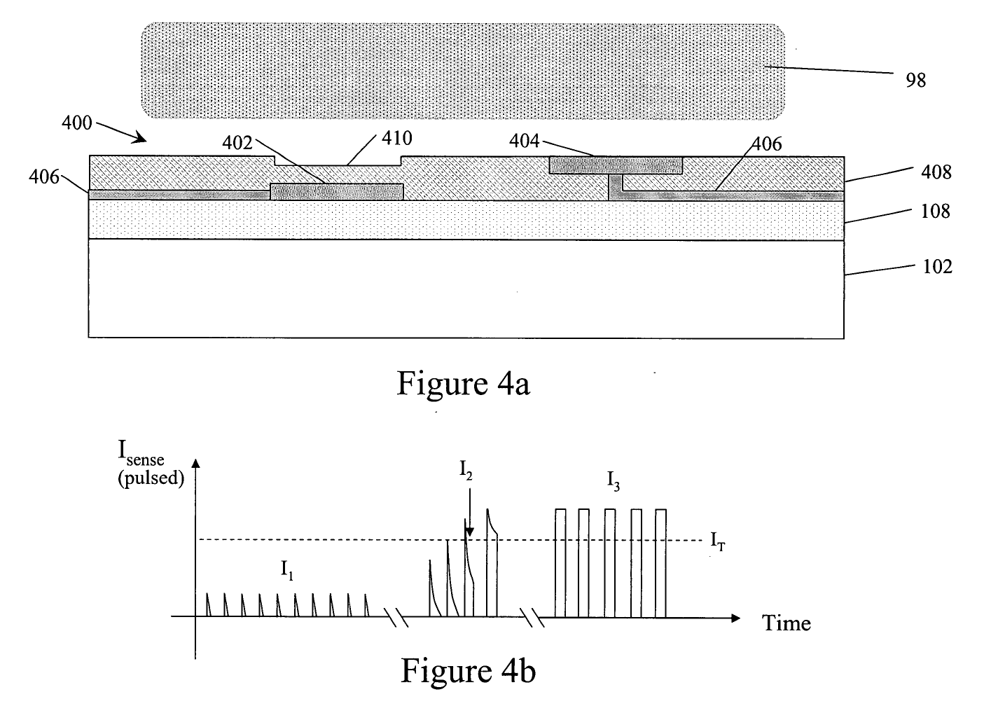

In alternative embodiments of the invention, data sensors that measure physical or electrical properties of a plasma are employed as diagnostic sensors for assessing the functional condition of a measurement device. FIGS. 4a and 4b illustrate the use of a dual floating Langmuir probe (DFP) as a diagnostic sensor in accordance with one embodiment of the invention. The general structure, function and utility of dual floating Langmuir probes as plasma data sensors is described for example in U.S. Pat. No. 6,830,650. Insulated dual floating Langmuir probe 400 comprises sensor electrode 402 disposed into a dielectric layer 108 upon the surface of wafer substrate 102. The DFP 400 further comprises a common electrode 404, which may be shared by other DFP diagnostic or data sensors. Electrodes 402 and 404 are connected electrically to interconnections 406 between the sensor 400 and controlling electronics of the plasma measurement device. Passivation layer 408 having thinned portion 410 is disposed over sensor electrode 402. The DFP device is stimulated with a pulsed voltage that in turn provides response current pulses I₁.

When a measurement device comprising sensor 400 is first exposed to a plasma environment, the ion current measured by sensor 400 is limited by the capacitive coupling through thinned portion 410 of the dielectric passivation layer. Due to the presence of passivation layer 410, response current pulses I₁ are weak. As thinned portion 410 of passivation layer 408 begins to wear in the presence of an etching or sputtering plasma, the magnitude of current pulses measured by sensor 400 increases to I₂, as illustrated in FIG. 4b. When electrode 402 is fully exposed, sensor 400 measures a maximum value of ion current pulses I₃. When the value of measured ion current exceeds a trigger value I_{T}, a diagnostic event is registered by the probe electronics. In an alternative embodiment, a diagnostic DFP sensor disposed upon a plasma probe for use in a dielectric deposition process records steadily decreasing values of ion current in response to deposition of dielectric material upon electrodes of the DFP sensor.

In response to detection by sensor 400 of an ion current that exceeds (or drops below) a threshold, the processing electronics of the plasma probe device may register a diagnostic event indicating that the useful life of the device has been expended. Alternatively, intermediate values of the DFP ion current measured by sensor 400 are used to predict the remaining useful life of the device prior to failure of the onboard data sensors and interconnections. To this end, the dimensions and/or composition of thinned dielectric portion 410 may be adjusted so as to provide a desired response of measured ion current to the degree of wear experienced by the diagnostic sensor and thereby provide more effective calibration of the sensor.

In one embodiment of the invention, an array of DFP sensors is disposed by stepped pattern transfer techniques upon a wafer-based plasma measurement probe. While most of the sensors are configured and interconnected for in-situ measurement of plasma properties in the vicinity of the probe, at least one DFP sensor has a consumable dielectric covering and is configured for use as a diagnostic or end-of-life sensor in an etch or sputtering process. In alternative embodiments, diagnostic or end-of-life sensors comprise such plasma data sensors as electrostatic charge sensors, ion energy sensors, or ion incidence angle sensors. The sensors are configured such that either erosion of a consumable covering layer or deposition of process materials results in measurable changes in plasma data readings from the sensor that can be correlated to the remaining useful lifetime of the plasma measurement device. Alternatively, the sensors are disposed as primary data sensors to measure rates or properties of substrate surface modification resulting from actions of the plasma, such as etch or deposition rates.

Diagnostic or end-of-life sensors of the invention may also comprise optical sensors for measuring emission or absorption spectroscopy, or light scattering or transmission characteristics of the plasma. In one embodiment of the invention, a plasma measurement device comprises an optical emission sensor disposed to sense radiance of the plasma. When the measurement device is exposed initially to a plasma etching environment, the optical emission sensor is covered by a consumable, optically opaque material that prevents plasma radiance from reaching the sensor. As the optically opaque layer wears away, the optical emission sensor begins to detect radiance emitted from the plasma. When a point of maximum radiant intensity is detected, for example by monitoring its rate of change or by comparison to a stored value or that of a collocated optical sensor, a diagnostic event is registered. Alternatively, an optical emission sensor disposed upon a plasma probe for use in a plasma deposition process records steadily decreasing values of plasma radiance due to deposition of opaque materials upon the optical sensor.

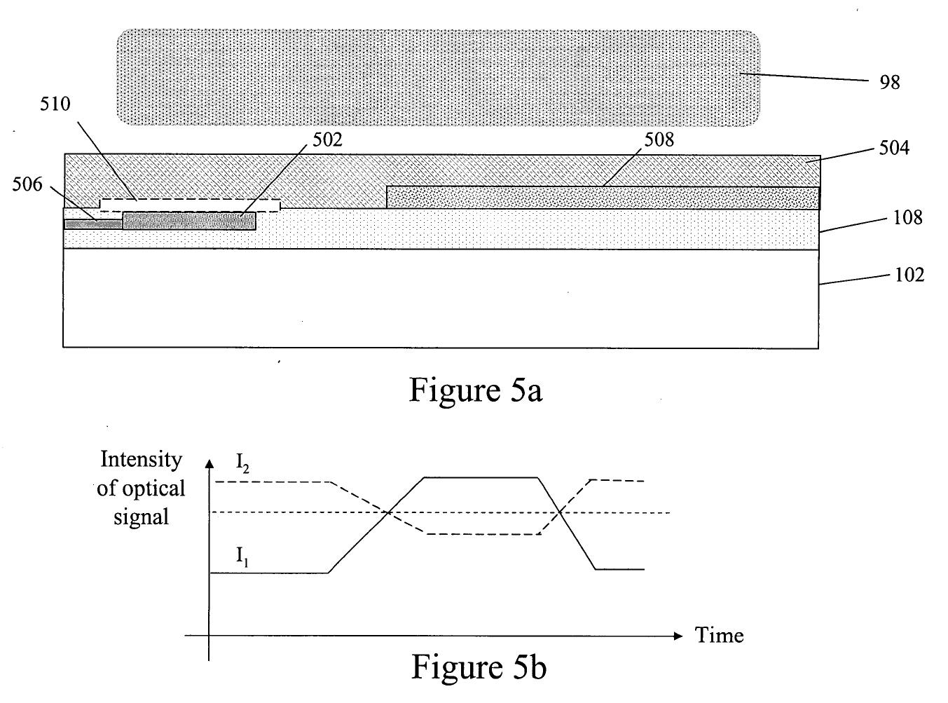

FIGS. 5a and 5b illustrates use of an optical sensor in accordance with another embodiment of the invention. In this embodiment, a plasma probe comprises one or more optical photo sensors 502 disposed on a dielectric layer 108 upon the surface of probe substrate 102, and electrically connected to interconnections 506 between the optical photo sensor 502 and controlling electronics of the probe. One ore more passivation layers 504 are disposed to protect the optical sensor 502 and interconnections 506 and other probe components from the plasma environment. In this embodiment, passivation layer is composed of a material transparent to the wavelengths of light to be collected by sensor 502. Alternatively, a separate transparent window is disposed upon sensor 502 so as not to obstruct collection of light from the plasma by the sensor.

Passivation layer 504 also covers reaction layer 508 comprising a material which, when exposed to the plasma etch or sputtering environment, releases one or more reaction products that either provides distinctive optical emission trace signals or that loads the gaseous plasma environment in such manner so as to alter the optical spectra emitted from the plasma. Photo sensor 502 also includes a passive spectrally selective filter 510 which discriminates and passes optical wavelengths associated with optical spectral lines or bands that are radiated by the plasma. In accordance with conventional photonic engineering practice, other light collimating, lensing and spectral filtering technologies may also be incorporated in the photo sensor construction.

When the probe device is first exposed to a plasma environment, reaction layer 508 is shielded from the plasma by passivation layer 504. As a result, filtered optical sensor 502 measures photo intensity signals associated with several line or band specific spectra emitted by the plasma processing environment. The photo sensor signals associated with two spectral lines or bands, I₁ and I₂, for example are recorded by the sensor electronics. When the passivation layer has been worn sufficiently to expose reaction layer 508 to the plasma, chemical species present in the plasma react with the material of reaction layer 508 to create reaction by-products, while the main portions of passivation layer 504 continues to protect the optical sensors, interconnections and related components. Reaction layer 508 is constructed preferably of carbon, silicon carbide, silicon nitride, or aluminum, for example, or such other materials whose reaction by-products are benign to the plasma process and associated equipment.

When the reaction by-products are liberated into the gaseous plasma, the plasma emits a distinctive radiant signature that is detected by sensor 502 and is seen as changes in the intensities of photo signals I₁ and I₂. A diagnostic event is then registered by the probe electronics when photo signal intensities, or the ratio of intensities, either exceed or fall below an established threshold. Alternatively, reaction layer 508 is disposed so as to be completely etched away while substantial portions of passivation layer 504 protecting probe components are still intact, and a diagnostic event is triggered upon sensing the absence of the optical emission spectrum of the reaction by-products. Where multiple photo signals are sensed, signal ratioing is the preferred method by which to determine if a diagnostic event has been reached since signal ratios are often more sensitive to subtle shifts in plasma chemistry as compared to the amplitude of optically emitted spectra. Moreover, the sensor data may be utilized in a predictive algorithm to estimate the remaining lifetime of the probe device. Although the optical emission sensor is integrated into the plasma probe device in the embodiment of FIGS. 5a and 5b, the sensor may alternatively be disposed at any location within the plasma processing environment from which the emission spectrum of the reaction by-products may be detected.

In an alternative embodiment, layer 508 as depicted in FIG. 5a is disposed not as a reactive layer, but as an optically reflective layer. A reflectometer, located at a distance from the probe device, projects a light beam onto the passivation layer covering the reflective layer and measures the intensity and wavelength of the light reflected. When the passivation layer has been etched away sufficiently to expose the reflective layer, the intensity and/or wavelength of light detected by the reflectometer changes, which in turn signals a diagnostic event.

Diagnostic sensors for determining the wear or end of life of the device may be disposed separately from primary data sensors of a measurement apparatus, or alternatively may be integrated into the topology of the primary data sensors themselves. In one embodiment, diagnostic sensors such as the fuse structure depicted in FIG. 2a, for example, are provided in the construction of interconnects with primary data sensors of a plasma measurement probe. When the signal from a data sensor is lost, a diagnostic event is triggered. The event may be regarded as a failure of the entire device or only as the failure of the individual primary sensor. As the device wears, the increase in failure events associated with multiple primary sensors may be used to determine the useful condition of the device as a whole or used in conjunction with diagnostic algorithms to predict the exposure time remaining before the failure of other working primary sensors.

In general, diagnostic events reported by sensors of the invention may be determinative of the useful lifetime of a plasma measurement device, or may be used for any diagnostic or predictive purpose relating to the functional condition or integrity of the device. Accordingly, sensors of the invention are constructed so as to register diagnostic events coincident with, subsequent to, or in anticipation of actual component failures of a plasma measurement device as may be appropriate to the particular device.

Diagnostic sensors of the invention are used in connection with transportable, wafer- or workpiece-based plasma probe devices, as well as with plasma measurement apparatus disposed at fixed locations within a process environment. In one embodiment of the invention, an array of plasma data sensors is disposed about the focus ring or dielectric isolation ring of a plasma processing system. In addition, one or more diagnostic sensors for measuring properties related to the functional condition of the data sensors are also disposed within the process environment. Data sensors and diagnostic sensors are connected by conductive paths to controlling electronics of the measurement apparatus. Diagnostic sensors are disposed so as to register diagnostic events after having been subjected to a degree of erosion, deposition, or other damaging action of the plasma. The diagnostic events may in turn indicate a need to modify data collection protocols, or to repair or replace the measurement apparatus.

Because diagnostic sensors of the invention respond to physical actions of the plasma, they may also be employed as data sensors in a plasma processing environment to measure physical process variables such as etch or deposition rates. In one embodiment of the invention, the capacitive “anti-fuse” structure depicted in FIG. 3a is adapted for use as an etch rate data sensor. An array of etch rate data sensors is disposed about the chamber liner, focus ring, dielectric isolation ring, gas injection ring, or other location within a plasma processing system in proximity to an etching plasma therein. Referring to FIG. 3a, a calibration procedure is used to determine a correlation between the thickness of the thinned portion 310 of dielectric passivation material covering embedded electrode 302 and the capacitance as measured between electrodes 302 and 304 in the presence of the plasma. Capacitance between electrodes of the sensors is measured by, for example, measuring a change in either shunt current or resonant frequency in response to a voltage pulse, or a change in capacitive charging roll-off or decay time. The etch rate sensors are removable and separable from driving electronics and electrical feed-throughs to facilitate replacement when passivation layers 310 have been fully consumed.

During operation, exposure to the plasma causes thinned passivation layers 310 of the sensors to be eroded and capacitance as measured between electrodes 302 and 304 to increase. Using the sensor calibration data, the etching rate of passivation layer 310 is computed. This etch rate measurement may translate directly to the etch rate occurring at the surface of a workpiece in the processing system, or may be correlated to the etch rates of dissimilar workpiece materials through additional calibration procedures. The etch rate may then be used in a predictive algorithm, alone or in conjunction with other measured or computed parameters, to compute the endpoint of an etching process with high accuracy. Data provided by etch rate sensors of the invention are also useful for development of process recipes; matching and optimization of process equipment; and for real-time monitoring, diagnosis, and closed-loop control of plasma processes.

In another embodiment of the invention, an optical emission sensor is adapted for use as a deposition rate sensor. One or more optical emission sensors are disposed within a plasma processing system in proximity to deposition plasma therein. A calibration procedure is used to determine a correlation between the thickness of optically opaque process material deposited upon the optical emission sensors and the intensity and/or wavelength of plasma radiance measured by the sensors. During operation, actual deposition rates of process material are determined using the sensor calibration data and measurements from the optical sensors. The deposition rate may then be used to compute the endpoint of a deposition process, or for other diagnostic or operational purposes. The optical emission sensors may be removable for cleaning or replacement, or alternatively the sensors may be cleaned of deposited material during normal cleaning cycles of the process chamber and the calibration of the sensors reset.

Although specific structure and details of operation are illustrated and described herein, it is to be understood that these descriptions are exemplary and that alternative embodiments and equivalents may be readily made by those skilled in the art without departing from the spirit and the scope of this invention. Accordingly, the invention is intended to embrace all such alternatives and equivalents that fall within the spirit and scope of the appended claims.

What is claimed is:

1. A plasma measurement device, comprising:
a) a primary substrate;
b) at least one data sensor disposed on the primary substrate for measuring properties of a plasma in a plasma processing environment; and
c) at least one diagnostic sensor disposed on the primary substrate for determining the functional integrity of the plasma measurement device.

2. The plasma measurement device of claim 1 wherein the at least one diagnostic sensor comprises a conductive strip that erodes upon exposure to the plasma.

3. The plasma measurement device of claim 2 wherein the functional integrity of the plasma measurement device is determined based on a change in electrical conductivity through the conductive strip.

4. The plasma measurement device of claim 2 wherein the conductive strip comprises a layer of doped poly-silicon.

5. The plasma measurement device of claim 1 wherein the at least one diagnostic sensor comprises a first electrode and a second electrode, and wherein the functional integrity of the plasma measurement device is determined using measurements of conductance or capacitance across the first electrode and the second electrode.

6. The plasma measurement device of claim 1 wherein the at least one diagnostic sensor comprises a dual floating Langmuir probe, and wherein the functional integrity of the plasma measurement device is determined using measurements of plasma ion currents by the dual floating Langmuir probe.

7. The plasma measurement device of claim 1 wherein the at least one diagnostic sensor comprises an optical sensor, and wherein the functional integrity of the plasma measurement device is determined using measurements of optical emission from the plasma.

8. The plasma measurement device of claim 7, further comprising a reactive layer disposed upon the primary substrate, the reactive layer producing reaction by-products upon exposure to the plasma, and wherein the functional integrity of the plasma measurement device is determined using measurements of optical emission from the reaction by-products.

9. The plasma measurement device of claim 1 wherein the at least one diagnostic sensor is disposed by pattern transfer upon the primary substrate.

10. The plasma measurement device of claim 1 comprising an array of diagnostic sensors disposed on the primary substrate for determining the functional integrity of the plasma measurement device.

11. The plasma measurement device of claim 1 wherein the functional integrity of the plasma measurement device is determined during exposure of the device to the plasma.

12. The plasma measurement device of claim 1, further comprising processing electronics disposed on the primary substrate and electrically interconnected to the at least one diagnostic sensor, and wherein the processing electronics determine the functional integrity of the plasma measurement device based upon data signals from the at least one diagnostic sensor.

13. The plasma measurement device of claim 1, further comprising a wireless communication interface disposed on the primary substrate for transmitting sensor data outside of the plasma processing environment.

14. The plasma measurement device of claim 1 wherein the primary substrate is a silicon wafer.

15. A method of determining the functional integrity of a plasma measurement device, comprising:
a) providing a plasma measurement device comprising a primary substrate, at least one data sensor disposed on the primary substrate for measuring properties of a plasma in a plasma processing environment, and least one diagnostic sensor disposed on the primary substrate;
b) exposing the plasma measurement device to the plasma; and
c) determining the functional integrity of the plasma measurement device using the at least one diagnostic sensor.

16. The method of claim 15 wherein the at least one diagnostic sensor comprises a conductive strip that erodes upon exposure to the plasma.

17. The method of claim 16 wherein the functional integrity of the plasma measurement device is determined based on a change in electrical conductivity through the conductive strip.

18. The method of claim 15 wherein the at least one diagnostic sensor comprises a first electrode and a second electrode, and wherein the functional integrity of the plasma measurement device is determined using measurements of conductance or capacitance across the first electrode and the second electrode.

19. The method of claim 15 wherein the at least one diagnostic sensor comprises a dual floating Langmuir probe, and wherein the functional integrity of the plasma measurement device is determined using measurements of plasma ion currents by the dual floating Langmuir probe.

20. The method of claim 15 wherein the at least one diagnostic sensor comprises an optical sensor, and wherein the functional integrity of the plasma measurement device is determined using measurements of optical emission from the plasma.

21. The method of claim 20, further comprising a reactive layer disposed upon the primary substrate, the reactive layer producing reaction by-products upon exposure to the plasma, and wherein the functional integrity of the plasma measurement device is determined using measurements of optical emission from the reaction by-products.

22. The method of claim 15 wherein the plasma measurement device further comprises processing electronics disposed on the primary substrate and electrically interconnected to the at least one diagnostic sensor, and wherein the processing electronics determine the functional integrity of the plasma measurement device using data signals from the at least one diagnostic sensor.

23. The method of claim 15 wherein the plasma measurement device further comprises a wireless communication interface disposed on the primary substrate for transmitting sensor data outside of the plasma processing environment.

24. The method of claim 15 wherein the primary substrate is a silicon wafer.

25. The method of claim 15 wherein the functional integrity of the plasma measurement device is determined during exposure of the device to the plasma.

26. The method of claim 15, further comprising the step of reporting a diagnostic event relating to the functional integrity of the plasma measurement device.

27. The method of claim 26 wherein the diagnostic event is reported prior to a failure of the plasma measurement device.

28. The method of claim 15, further comprising the step of estimating the remaining useful lifetime of the plasma measurement device using data signals from the at least one diagnostic sensor.
